(19) United States
(12) Patent Application Publication
(10) Pub. No.: US 2026/0068004 A1
(43) Pub. Date: Mar. 5, 2026

(54) HMI INDUCTION UNDER COUNTERTOP

(71) Applicant: WHIRLPOOL CORPORATION, BENTON HARBOR, MI (US)

(72) Inventors: Salvatore Baldo, Varese (IT); Mario Barbati, Sulmona (IT); Andrea Gallivanoni, Casorate Sempione (IT)

(73) Assignee: WHIRLPOOL CORPORATION, BENTON HARBOR, MI (US)

(21) Appl. No.: 18/816,051

(22) Filed: Aug. 27, 2024

(51) Int. Cl. H05B 6/06; H05B 1/02; H05B 6/12

(52) U.S. Cl. CPC H05B 6/062; H05B 1/0202; H05B 6/1218

(57) ABSTRACT

A countertop cooking appliance includes a countertop defining a work surface, at least one burner coupled to the countertop, and a proximity sensor. A communication module is configured to be in wireless communication with a user interface device that is moveable relative to the countertop. A control system is configured to determine a proximity of the user interface device to the proximity sensor. If the user interface device is outside of a threshold distance from the proximity sensor, the control system determines if the at least one burner is energized, and, if the at least one burner is energized, generate an instruction to de-energize the at least one burner.

### FIELD OF THE DISCLOSURE

The present disclosure generally relates to a countertop cooking appliance with integrated burners and a control system of the countertop cooking appliance.

### BACKGROUND

Appliance integration into existing kitchen furnishings and cabinetry has increased in popularity among consumers. The integration saves space and provides flexibility for improvements and personalization of kitchen décor. For example, it has become a modern trend to integrate cooking appliances, like burners of a cooktop, into countertops in the kitchen. The integration of burners into the countertop saves space in the kitchen and provides a sleek aesthetic to the kitchen décor. However, while the burners are generally embedded in the countertop and unseen or hard to see, space needs to be utilized for a user interface device. As such, often the countertop with integrated burners requires knobs, a user interface device embedded in and visible on the countertop proximate the embedded burners, or a user interface device hidden by, for example, a drawer in the countertop. Furthermore, because the burners are typically unseen or hard to see, safety concerns must be considered to ensure a user is physically present while the burners are energized.

Accordingly, the present disclosure provides a countertop cooking appliance with integrated burners and a control system for the countertop cooking appliance.

### SUMMARY OF THE DISCLOSURE

According to one aspect of the present disclosure, a countertop cooking appliance includes a countertop defining a work surface, at least one burner coupled to the countertop, and a proximity sensor. A communication module is configured to be in wireless communication with a user interface device that is moveable relative to the countertop. A control system is configured to determine a proximity of the user interface device to the proximity sensor. If the user interface device is outside of a threshold distance from the proximity sensor, the control system determines if the at least one burner is energized, and, if the at least one burner is energized, generate an instruction to de-energize the at least one burner.

According to another aspect of the present disclosure, a countertop cooking appliance includes a countertop defining a work surface, at least one burner coupled to the countertop, and a proximity sensor. A communication module is configured to be in wireless communication with a user interface device that is moveable relative to the countertop. A designated area is on the work surface and aligned with the proximity sensor that includes an indication for notifying a user to place the user interface device on the designated area. A control system is configured to only permit operating the at least one burner if the user interface device is located on the designated area.

According to yet another aspect of the present disclosure, a countertop cooking appliance includes a countertop defining a work surface, at least one burner coupled to the countertop, and a proximity sensor. A communication module is configured to be in wireless communication with a user interface device that is moveable relative to the countertop. A designated area is on the work surface and aligned with the proximity sensor that includes an indication for notifying a user to place the user interface device on the designated area. A control system is configured to determine a proximity of the user interface device to the designated area, and, if the user interface device is within a threshold distance from the designated area, permit communications between the user interface device and the communication module to control a setting of the at least one burner.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front-upper perspective view of a countertop cooking appliance with a proximity sensor, according to an aspect of the present disclosure;

FIG. 2 is a side cross-sectional view of a countertop cooking appliance with a proximity sensor, according to an aspect of the present disclosure;

FIG. 3 is a front-upper perspective view of a countertop cooking appliance with a cooktop panel and a proximity sensor, according to an aspect of the present disclosure;

FIG. 4A is a partial top perspective view of a countertop cooking appliance with a designated area having a textured surface, according to an aspect of the present disclosure;

FIG. 4B is a partial top perspective view of a countertop cooking appliance with a designated area having a pocket, according to an aspect of the present disclosure;

FIG. 4C is a partial top perspective view of a countertop cooking appliance with a designated area having a light, according to an aspect of the present disclosure;

FIG. 4D is a partial top perspective view of a countertop cooking appliance with a designated area receiving a projected illumination, according to an aspect of the present disclosure;

FIG. 5 is a schematic view of a countertop cooking appliance utilizing threshold distances in a control scheme, according to an aspect of the present disclosure; and

FIG. 6 is a schematic view of a control system of a countertop cooking appliance, according to an aspect of the present disclosure.

The components in the figures are not necessarily to scale, emphasis instead being placed upon illustrating the principles described herein.

### DETAILED DESCRIPTION

The present illustrated embodiments reside primarily in a countertop cooking appliance with integrated burners and a control system for the countertop cooking appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

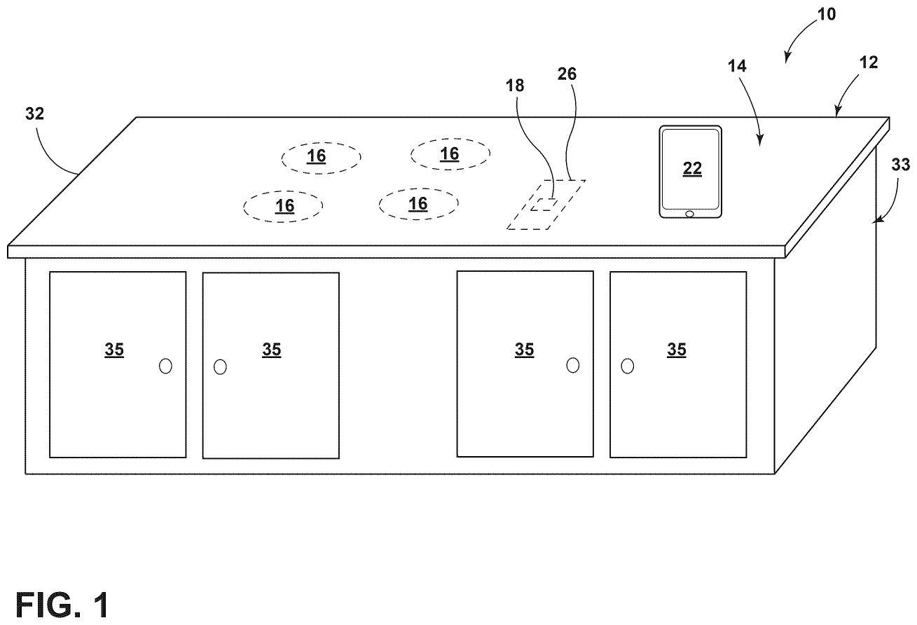

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer and/or user, and the term “rear” shall refer to the surface of the element further from the intended viewer and/or user. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

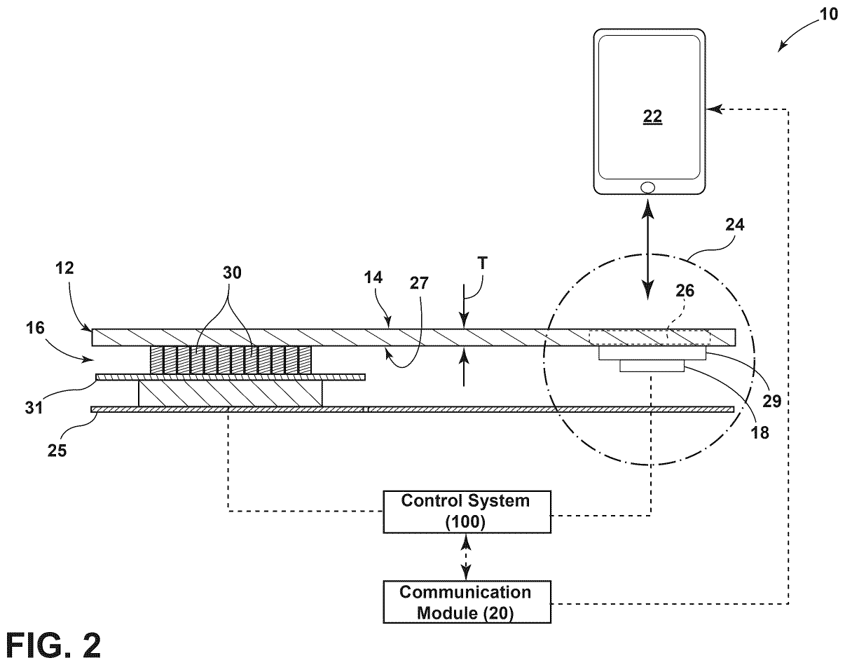

Referring initially to FIGS. 1 and 2, reference numeral 10 generally designates a countertop cooking appliance. The countertop cooking appliance 10 includes a countertop 12 defining a work surface 14, at least one burner 16 coupled to the countertop 12, and a proximity sensor 18. A communication module 20 is configured to be in wireless communication with a user interface device 22 that is moveable relative to the countertop 12. A control system 100 (e.g., a processor 104) is configured to determine a proximity of the user interface device 22 to the proximity sensor 18. If the user interface device 22 is outside of a threshold distance 24 from the proximity sensor 18, the control system 100 (e.g., the processor 104) determines if the at least one burner 16 is energized, and, if the at least one burner 16 is energized, generate an instruction to de-energize the at least one burner 16.

The work surface 14 may include a designated area 26 associated with the proximity sensor 18. In some embodiments, the threshold distance 24 may be associated with a distance from the designated area 26. For example, the proximity sensor 18 may be located below the work surface 14 (e.g., on an undersurface 27 of the countertop 12), within a hole (e.g., a blind hole extending from the undersurface 27 of the countertop), on the work surface 14 and/or other locations. The proximity sensor 18 may be aligned with the designated area 26. More particularly, the designated area 26 may include an indication 28 for notifying a user to place the user interface device 22 on the designated area 26. In this manner, the proximity sensor 18 may be configured to determine proximity between the user interface device 22 and the proximity sensor 18, which is proximate to the designated area 26. In some embodiments, the proximity sensor 18 may include one of a Radio Frequency Identification (“RFID”) sensor, a Near Field Communication (“NFC”) sensor, and/or other types of location and proximity sensors. In some embodiments, a charging module 29 may be located in or proximate the designated area 26. For example, the charging module 29 may be configured as an induction charging device that charges the user interface device 22 via direct contract or through the work surface 14.

In some embodiments, the threshold distance 24 may require that the user interface device 22 is located on (e.g., rested on) the designated area 26 before permitting the user interface device 22 to transmit instructions for controlling the settings of the at least one burner 16. In some embodiments, the threshold distance 24 may permit the user interface device 22 to be moved within a threshold distance from the designated area 26 before permitting the user interface device 22 to transmit instructions for controlling the settings of the at least one burner 16. For example, the threshold distance 24 may be about 1 meter or less, about 2 meters or less, about 3 meters or less, about 4 meters or less, or about 5 meters or less. In some embodiments, the threshold distance 24 may initially require that the user interface device 22 is located on (e.g., rested on) the designated area 26 for initial confirmation of the presence of the user before controlling settings of the at least one burner 16. After the initial confirmation of the presence of the user, the threshold distance 24 may be expanded to permit the user interface device 22 to be moved within the expanded threshold distance 24 from the designated area 26 while still allowing the user interface device 22 to transmit instructions for controlling the settings of the at least one burner 16 until the user interface device 22 is removed from the expanded threshold distance 24.

In some embodiments, the threshold distance 24 (e.g., the initial and expanded threshold distances) may be associated with limiting only certain control settings of the at least one burner 16. For example, when the user interface device 22 is outside of the threshold distance 24, certain functionalities, such as timers, lights, status checks, and/or the like may still be available to the interface device 22. Likewise, when the user interface device 22 is outside of the threshold distance 24, the user interface device 22 may generate an alert (e.g., audible or visual) to notify a user that all or certain control functionalities are no longer available. If the at least one burner 16 is energized and the user interface device 22 is outside of the threshold distance 24, the control system 100 (e.g., the processor 104) may generate the instruction to de-energize the at least one burner 16 either automatically or manually. For example, the instruction to de-energize the at least one burner 16 automatically may include no user intervention for the automatic de-energization. The instruction to de-energize the at least one burner 16 manually may include user intervention for the de-energization (e.g., in conjunction with the alert).

With continued reference to FIGS. 1 and 2, the at least one burner 16 may include one, two, three, or more burners 16. The at least one burner 16 may employ a variety of heating technologies, such as induction heating, electric heating, gas heating, and heating that employs all fuel types. In some embodiments, the at least one burner 16 may rest on a support plate 25 located under the countertop 12 and connected to the countertop 12 via brackets, fasteners, and/or the like. In some embodiments, the at least one burner 16 employs induction heating and includes magnetic coils 30 that may be located on a coil tray 31. One or more printed circuit boards (PCB) may be configured to control operation of the at least one burner 16 (e.g., on-off and temperature settings). The proximity sensor 18 and the communication module 20 may be located on and/or otherwise in operable communication with the one or more PCBs. In operation, when the magnetic coils 30 are energized, heat is imparted to an induction compatible pot or a pan. As best depicted in FIG. 2, the at least one burner 16 may be located under the work surface 14. For example, the work surface 14 may extend continuously and be defined by a peripheral edge 32. The at least one burner 16 may be located below the work surface 14. In some embodiments, the at least one burner 16 is in contact with or in close proximity to the undersurface 27 of the countertop 12. The countertop 12 may include a thickness (“T”) defined between the work surface 14 and the undersurface 27. The thickness T may be between about 0.5 cm and 3 cm, for example, between about 1 cm and 2 cm, or about 1.5 cm. In some embodiments, the thickness T may be substantially uniform between the peripheral edge 32. In some embodiments, the thickness T may include one or more variations (e.g., via depression on the undersurface 27) for locating one or more of the at least one burner 16, the proximity sensor 18, the communication module 20, and/or other components of the countertop cooking appliance 10. The countertop 12 may be formed of a countertop material, such as a ceramic material, such as porcelain stoneware, quartz, and/or the like. As depicted in FIG. 1, the countertop 12 may be located on cabinet 33 such that the countertop 12 is at a desired height. The cabinet 33 may define drawers 35 for storage and access to the burners 16 and other electrical components of the countertop cooking appliance 10.

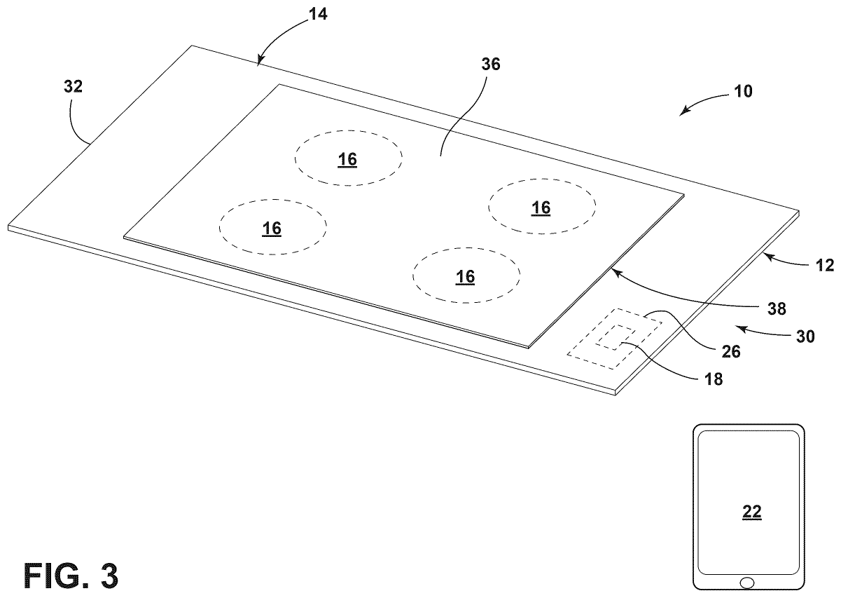

With reference now to FIG. 3, in some embodiments, rather than the work surface 14 extending continuously between the peripheral edge 32 as a solid material, the work surface 14 may define an aperture. In this manner, a cooking panel 36 may be located at least partially in or over the aperture and the at least one burner 16 may be located under the cooking panel 36. The cooking panel 36 may include a top panel surface 38 that may be substantially flush with and partially define the work surface 14. The cooking panel 36 may be formed from a panel material which may be the same or different than the countertop material. For example, the cooking panel material may include a glass or glass-ceramic material. In some embodiments, the cooking panel 36 is color and design matched with the countertop 12 for providing a work surface 14 that appears as a single uninterrupted material. For purposes of this disclosure, it should be appreciated that the work surface 14 includes the cooking panel top surface 38. The depicted arrangement in FIG. 3 may be beneficial for localizing materials over the burners 16 that are compatible with and able to withstand heat generated by the burners 16 without requiring that the entire countertop 12 is formed of the same material.

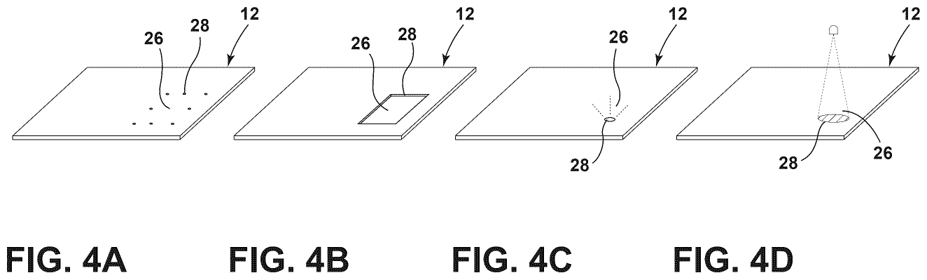

With reference now to FIGS. 4A-4D, regardless of the construction of the countertop 12 (e.g., the materials, the number of burners 16, and the presence or absence of the cooking panel 36), the control system 100 (e.g., the processor 104) utilizes the indication 28 to notify the user of the designated area 26 location. With reference to FIG. 4A, the indication 28 may, for example, include a textured surface on the work surface 14 or top panel surface 38. The textured surface may include, for example, raised shapes (e.g., dots, lines, etc.), embossments, depressions, and or the like. The charging module 29 may be located under or partially define the textured surface. With reference now to FIG. 4B, the indication 28 may, for example, include a pocket in the work surface 14 or top panel surface 38. The pocket may be sized to locate at least a portion of the user interface device 22. For example, the pocket may be sized to fit an entire bottom surface or side edge surface of the user interface device 22. The charging module 29 may be located under or at least partially define the pocket. With reference now to FIG. 4C, the indication 28 may, for example, include a light with (e.g., embedded in or otherwise located in a hole), under, or on top of the work surface 14 or top panel surface 38. The light may be configured to generate visible illumination onto the designated area 26. In some embodiments, the light may only be configured to illuminate when the user interface device 22 is proximate the countertop 12 and/or via instructions from the user interface device 22. In some embodiments, a portion of the countertop 12 is at least partially transmissive to the light. The charging module 29 may be located under or proximate the light. The light may be a single illumination dot or shape or a pattern defining an outer edge of the designated area 26. With reference now to FIG. 4D, the indication 28 may, for example, include a light remote from the countertop 12 and configured to project an illumination onto the work surface 14 or top panel surface 38. The illumination is projected onto the designated area 26. In some embodiments, the light may only be configured to generate the illumination when the user interface device 22 is proximate the countertop 12 and/or via instructions from the user interface device 22. The charging module 29 may be located under designated area 26. The generated illumination may be a single dot or shape or a pattern defining an outer edge of the designated area 26.

With continued reference to FIGS. 4A-4D, it should be appreciated that the indication 28 may have a configuration other than or in addition to the textured surface, the pocket sized to locate at least a portion of the user interface device 22, the light coupled to the countertop 12, and the light remote from the countertop and configured to project an illumination onto the work surface 14. For example, the indication 28 may include a region of the countertop 12 that is colorized (e.g., a dye in the countertop material, a paint or acrylic on the countertop 12), a non-integral material that is coupled to the countertop 12 (e.g., a component adhered to the countertop indicating the designated area 26), and/or the like. In some embodiments, the location of the designated area 26 may be transmitted from the user interface device 22 to the user. For example, the user interface device 22 may include a display that generates navigational tools for where the designated area 26 is located.

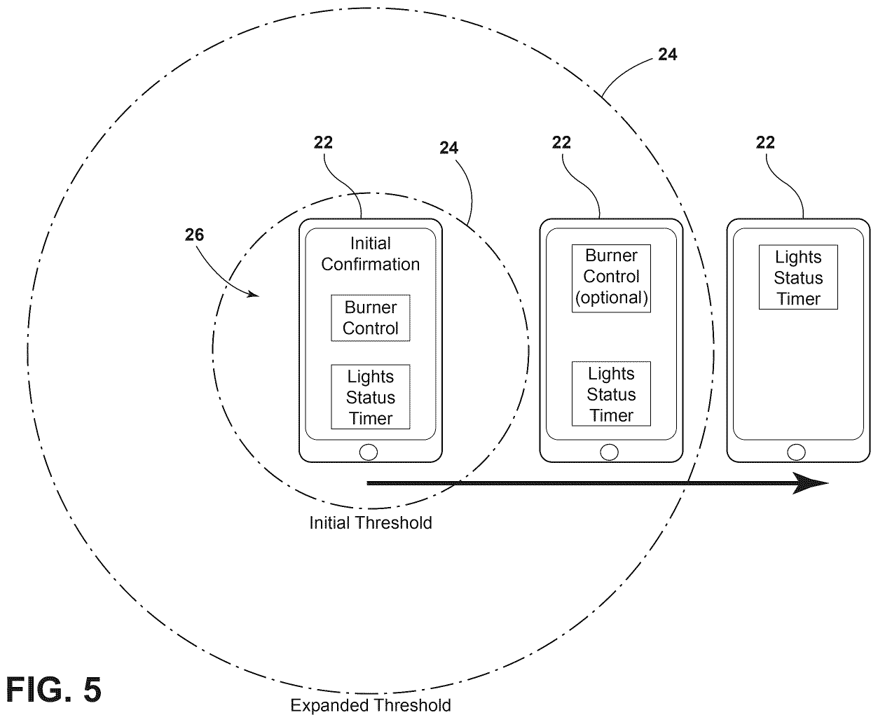

With reference now to FIG. 5, the user interface device 22 may include one of a mobile phone, a tablet, or a personal computing device operating, for example, via web-based, local, or standalone applications. In this manner, a user may utilize personal devices for the user interface device 22. In some embodiments, rather than or in addition to the personal devices, the user interface device 22 may include a designated device configured specifically for the countertop cooking appliance 10, and, optionally, other appliances in a kitchen or home in addition to the countertop cooking appliance 10.

Regardless of the configuration of the user interface device 22 and designated area 26, the control system 100 (e.g., the processor 104) via communication with the proximity sensor 18 is configured to ensure that the user is in close proximity to the at least one burner 16 by determining that the user interface device 22 is in the designated area 26 to energize and before allowing instructions to heat the at least one burner 16. In other words, the control system 100 may only permit operating the at least one burner 16 if the user interface device 22 is located on/in and/or within the threshold distance 24 of the designated area. As detailed in the previous paragraphs, the threshold distance 24 may be a singular expanded distance associated with full control between the user interface device 22 and the at least one burner 16, permitting a user to move around with the user interface device 22, for example, in the kitchen or proximate locations to the at least one burner 16. The threshold distance 24 may, alternatively, require that the user interface device 22 is located on the designated area 26 (e.g., a singular short distance) in order to obtain full control between the user interface device 22 and the at least one burner 16. In addition, the threshold distance 24 may, alternatively, require that the user interface device 22 is initially located on the designated area 26 (e.g., a short distance) in order to obtain access to full control between the user interface device 22 and the at least one burner 16. After the access to full control is obtained by the user interface device 22, the threshold distance 24 may be modified to the expanded distance to allow a user to move around with the user interface device 22. In some embodiments, the parameters of the threshold distance 24 may be selected by a user, via the user interface device 22, or automatically updated via connection to, for example, the internet. The parameters of the threshold distance 24 may automatically be updated, for example, based on regional and local safety rules.

The threshold distance 24 parameters may be particularly associated with certain types of control settings available to the user interface device 22. For example, when the user interface device 22 is outside of the threshold distance 24, certain functionalities, such as timers, lights, status checks, and/or the like may still be available to the interface device 22. However, the user interface 22 is prevented from energizing the at least one burner 16 when the user interface 22 is outside of the threshold distance. Likewise, when the user interface device 22 is outside of the threshold distance 24, if the at least one burner 16 is energized, the control system 100 (e.g., the processor 104) may generate the signal to manually or automatically de-energize the at least one burner 16.

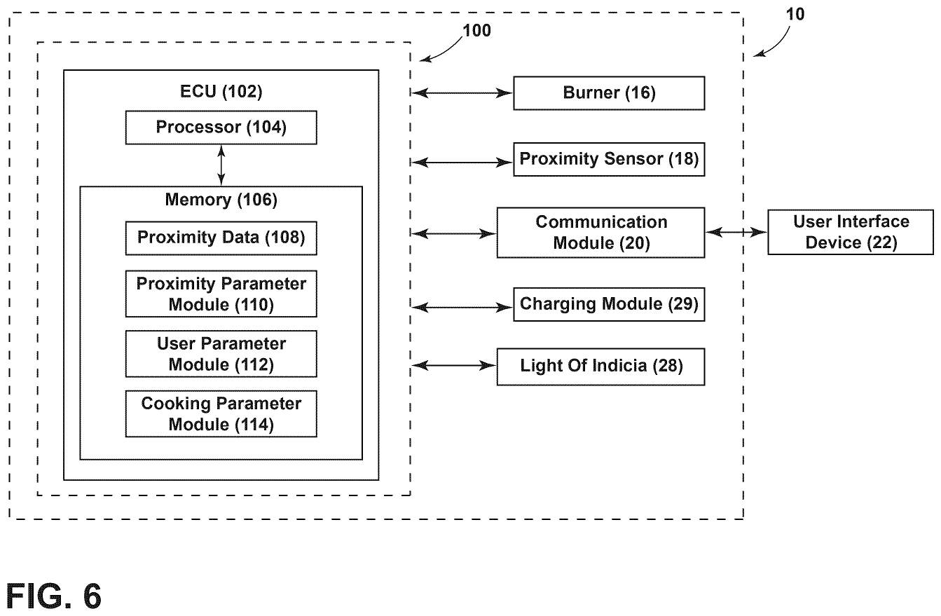

With reference now to FIG. 6, the control system 100 is schematically illustrated. The control system 100 may include components coupled to the at least one burner 16, components coupled to the user interface device 22, or components coupled to both the at least one burner 16 and the user interface device 22. The control system 100 may include an electronic control unit (ECU) 102. The ECU 102 may include the processor 104 and a memory 106. The processor 104 may include any suitable processor 104. Additionally, or alternatively, the ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid-state) memory, other non-transitory storage mediums, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the control system 100. The at least one burner 16, the proximity sensor 18, the communication module 20, the user interface device 22, and the charging module 29 may therefore be controlled by and/or receive instructions from the ECU 102. The memory 106 may therefore include proximity data 108, a proximity parameter module 110, a user parameter module 112, and a cooking parameter module 114.

With continued reference to FIG. 6, the proximity data 108 may include data received from the proximity sensor 18. For example, the data received from the proximity sensor 18 may include proximity details, for example, the distance between the user interface device 22 and the proximity sensor 18. In some embodiments, the data received from the proximity sensor 18 may include raw data related to signal strength between the user interface device 22 and the proximity sensor 18 that is extrapolated via the processor 104 to determine proximity details.

The proximity parameter module 110 may include threshold information (e.g., distance), parameters (singular close distance, singular expanded distance, or combinations thereof), and guidelines on when and which settings (e.g., energizing the at least one burner 16) are restricted based on the location of the user interface device 22 relative to the threshold information. The proximity parameter module 110 may be modified by a user, via the user interface device 22, or automatically updated via connection to, for example, the internet. The parameters of the threshold distance 24 may automatically be updated, for example, based on regional and local safety rules.

The user parameter module 112 may include, for example, alert settings and which user interfaces devices 22 are paired with the at least one burner 16 (e.g., via the communication module 20). The user parameter module 112 may further include which graphics are generated on a display of the user interface device 22 and ways in which the user can interface with the user interface device 22 (e.g., voice activation, user input layouts, etc.).

The cooking parameter module 114 may include, for example, cooking settings, cooking cycle options, burner selection (e.g., which burner(s) 18 to energize), and/or the like. The cooking parameter module 114 may be restricted to certain available settings based on the location of the user interface device 22 relative to the threshold information (e.g., via the proximity parameter module 110). For example, the cooking parameter module 114 may restrict the user from energizing the at least one burner 16 if the user interface device 22 is outside of the threshold distance 24. Likewise, the cooking parameter module 114 may automatically generate an instruction to de-energize the at least one burner 16 if the user interface device 22 is outside of the threshold distance 24.

The disclosure herein is further summarized in the following paragraphs and is further characterized by combinations of any and all of the various aspects described therein.

According to one aspect of the present disclosure, a countertop cooking appliance includes a countertop defining a work surface, at least one burner coupled to the countertop, and a proximity sensor. A communication module is configured to be in wireless communication with a user interface device that is moveable relative to the countertop. A control system is configured to determine a proximity of the user interface device to the proximity sensor. If the user interface device is outside of a threshold distance from the proximity sensor, the control system determines if the at least one burner is energized, and, if the at least one burner is energized, generates an instruction to de-energize the at least one burner.

According to another aspect, a work surface includes a designated area associated with a proximity sensor.

According to yet another aspect, a designated area includes an indication for notifying a user to place a user interface device on the designated area.

According to yet another aspect, an indication on a designated area includes a pocket sized to locate at least a portion of the user interface device therein.

According to another aspect, an indication on a designated area includes a light coupled to the countertop.

According to yet another aspect, the light is located below the work surface.

According to still another aspect, an indication on a designated area includes a light remote from a countertop and configured to project an illumination onto a work surface.

According to another aspect, a user interface device includes one of a mobile phone, a tablet, or a personal computing device.

According to yet another aspect, a work surface defines an aperture and a cooking panel is located in the aperture, and at least one burner is located under the cooking panel.

According to still another aspect, a threshold distance includes at least a first and a second threshold distance. A control system is configured to detect that a user interface device is in the first threshold distance from a proximity sensor before permitting the user interface device to energize the at least one burner. After detecting the user interface device in the first threshold distance, the control system expands the first threshold distance to a second threshold distance, and, if the user interface device is moved outside of the second threshold distance from the proximity sensor, generate an instruction to de-energize the at least one burner.

According to another aspect, a countertop is formed of a ceramic material.

According to yet another aspect, a proximity sensor includes one of an RFID or an NFC sensor.

According to another aspect of the present disclosure, a countertop cooking appliance includes a countertop defining a work surface, at least one burner coupled to the countertop, and a proximity sensor. A communication module is configured to be in wireless communication with a user interface device that is moveable relative to the countertop. A designated area is on the work surface and aligned with the proximity sensor that includes an indication for notifying a user to place the user interface device on the designated area. A control system is configured to only permit operating the at least one burner if the user interface device is located on the designated area.

According to another aspect, a control system is configured to determine if at least one burner is energized, and, if the at least one burner is energized and a user interface device for the at least one burner is removed from a designated area, generate an instruction to de-energize the at least one burner.

According to yet another aspect, the instruction is generated to automatically de-energize the at least one burner.

According to yet another aspect, an indication for a designated area is selected from a group comprising a textured surface, a pocket sized to locate at least a portion of the user interface device a light coupled to the countertop, or a light remote from the countertop and configured to project an illumination onto the work surface.

According to yet another aspect of the present disclosure, a countertop cooking appliance includes a countertop defining a work surface, at least one burner coupled to the countertop, and a proximity sensor. A communication module is configured to be in wireless communication with a user interface device that is moveable relative to the countertop. A designated area is on the work surface and aligned with the proximity sensor that includes an indication for notifying a user to place the user interface device on the designated area. A control system is configured to determine a proximity of the user interface device to the designated area, and, if the user interface device is within a threshold distance from the designated area, permit communications between the user interface device and the communication module to control a setting of the at least one burner.

According to another aspect, a control system is configured to, if a user interface device is outside the threshold distance from a designated area, restrict controlling a setting of at least one burner.

According to yet another aspect, a control system is configured to, determine that at least one burner is energized, and, if a user interface device is outside a threshold distance from a designated area, de-energize at least one burner.

According to still another aspect, an indication of a designated area is selected from a group comprising a textured surface, a pocket sized to locate at least a portion of the user interface device a light coupled to the countertop, or a light remote from the countertop and configured to project an illumination onto the work surface.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about. ” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A countertop cooking appliance comprising:
a countertop defining a work surface;
at least one burner coupled to the countertop;
a proximity sensor;
a communication module configured to be in wireless communication with a user interface device that is moveable relative to the countertop; and
a control system configured to:
determine a proximity of the user interface device to the proximity sensor;
if the user interface device is outside of a threshold distance from the proximity sensor, determine if the at least one burner is energized; and
if the at least one burner is energized, generate an instruction to de-energize the at least one burner.

2. The countertop cooking appliance according to claim 1, wherein the work surface includes a designated area associated with the proximity sensor.

3. The countertop cooking appliance according to claim 2, wherein the designated area includes an indication for notifying a user to place the user interface device on the designated area.

4. The countertop cooking appliance according to claim 3, wherein the indication includes a pocket sized to locate at least a portion of the user interface device therein.

5. The countertop cooking appliance according to claim 3, wherein the indication includes a light coupled to the countertop.

6. The countertop cooking appliance according to claim 5, wherein the light is located below the work surface.

7. The countertop cooking appliance according to claim 3, wherein the indication includes a light remote from the countertop and configured to project an illumination onto the work surface.

8. The countertop cooking appliance according to claim 1, wherein the user interface device includes one of a mobile phone, a tablet, or a personal computing device.

9. The countertop cooking appliance according to claim 1, wherein the work surface defines an aperture and a cooking panel is located in the aperture, the at least one burner located under the cooking panel.

10. The countertop cooking appliance according to claim 1, wherein the threshold distance includes at least a first and a second threshold distance, and the control system is further configured to:
detect that the user interface device is in the first threshold distance from the proximity sensor before permitting the user interface device to energize the at least one burner;
after detecting the user interface device in the first threshold distance, expand the first threshold distance to a second threshold distance; and
if the user interface device is moved outside of the second threshold distance from the proximity sensor, generate the instruction to de-energize the at least one burner.

11. The countertop cooking appliance according to claim 1, wherein the countertop is formed of a ceramic material.

12. The countertop cooking appliance according to claim 1, wherein the proximity sensor includes one of an RFID or an NFC sensor.

13. A countertop cooking appliance comprising:
a countertop defining a work surface;
at least one burner coupled to the countertop;
a proximity sensor;
a communication module configured to be in wireless communication with a user interface device that is moveable relative to the countertop;
a designated area on the work surface aligned with the proximity sensor that includes an indication for notifying a user to place the user interface device on the designated area; and
a control system configured to:
only permit operating the at least one burner if the user interface device is located on the designated area.

14. The countertop cooking appliance according to claim 13, wherein the control system is further configured to:
determine if the at least one burner is energized; and
if the at least one burner is energized and the user interface device is removed from the designated area, generate an instruction to de-energize the at least one burner.

15. The countertop cooking appliance according to claim 14, wherein the instruction is generated to automatically de-energize the at least one burner.

16. The countertop cooking appliance according to claim 13, wherein the indication is selected from a group comprising a textured surface, a pocket sized to locate at least a portion of the user interface device a light coupled to the countertop, or a light remote from the countertop and configured to project an illumination onto the work surface.

17. A countertop cooking appliance comprising:
a countertop defining a work surface;
at least one burner coupled to the countertop;
a proximity sensor;
a communication module configured to be in wireless communication with a user interface device that is moveable relative to the countertop;
a designated area proximate the proximity sensor on the work surface with an indication for notifying a user to place the user interface device on the designated area; and
a control system configured to:
determine a proximity of the user interface device to the designated area; and
if the user interface device is within a threshold distance from the designated area, permit communications between the user interface device and the communication module to control a setting of the at least one burner.

18. The countertop cooking appliance according to claim 17, wherein the control system is further configured to:
if the user interface device is outside the threshold distance from the designated area, restrict controlling the setting of the at least one burner.

19. The countertop cooking appliance according to claim 18, wherein the control system is further configured to:
determine that the at least one burner is energized; and
if the user interface device is outside the threshold distance from the designated area, de-energize the at least one burner.

20. The countertop cooking appliance according to claim 17, wherein the indication is selected from a group comprising a textured surface, a pocket sized to locate at least a portion of the user interface device a light coupled to the countertop, or a light remote from the countertop and configured to project an illumination onto the work surface.
